(19) United States
(12) Patent Application Publication
(10) Pub. No.: US 2019/0285392 A1
(43) Pub. Date: Sep. 19, 2019

(54) FLASH DEVICE

(71) Applicant: BAE SYSTEMS plc, London (GB)

(72) Inventors: DANIEL BENJAMIN BLACK, Chelmsford Essex (GB); MICHAEL JAMES PARKER, Chelmsford Essex (GB); MOHAMMED-ASIF AKHMAD, Chelmsford Essex (GB); STUART JAMES TOMS, Chelmsford Essex (GB)

(73) Assignee: BAE SYSTEMS plc, London (GB)

(21) Appl. No.: 16/349,776

(22) PCT Filed: Nov. 13, 2017
(86) PCT No.: PCT/GB2017/053415

§ 371 Date: May 14, 2019

(30) Foreign Application Priority Data
Nov. 15, 2016 (GB) 1619313.8
Jan. 12, 2017 (EP) 17151164.5

(51) Int. Cl. F42B 27/00; F42B 12/42; F41H 13/00; H05B 33/08

(52) U.S. Cl. CPC F42B 27/00; F42B 12/42; H05B 33/0818; F41H 13/0081; F41H 13/0087

(57) ABSTRACT

There is disclosed a flash device for selective activation where upon activation the device may emit at least 100,000 lumens, the flash device comprising, an operator interface, a power unit comprising an energy store, at least one light emission unit connected to the power unit and comprising an array of light emitting elements, a power converter unit for driving the array, a control unit operably connected to the at least one light emission unit, the control unit comprising a processor and being operably connected to the operator interface.

The present invention relates to a flash device.

It is known from U.S. Pat. No. 8,113,689 to provide a non-pyrotechnic projectile capable of emitting 100,000 candelas per square metre and which may be selectively activated to disorientate nearby personnel. U.S. Pat. No. 8,113,689 discloses a power source interfaced with a centralised control electronics unit. The control electronics connect to various light generators.

According to a first aspect of the invention there is provided a flash device for selective activation where upon activation the device may emit at least 100,000 lumens, the flash device comprising, an operator interface, a power unit comprising an energy store, at least one light emission unit connected to the power unit and comprising an array of light emitting elements, a power converter unit for driving the array, a control unit operably connected to the at least one light emission unit, the control unit comprising a processor and being operably connected to the operator interface.

As such a flash device is provided which supplies energy to in an efficient manner and thereby tends to make good use of the available energy, e.g. as stored in the energy store, such that a smaller energy store may be used.

Such an energy store can be tuned to deliver power in a particularly responsive manner and so can therefore permit higher switching frequencies of the light emitting element arrays.

The energy store may contain only a capacitive energy store.

Such a capacitive energy store ensures that the flash device can be safely used in potentially explosive atmospheres as no inductive energy store or inductive energy sink is used, for example, there is no lithium battery present.

The flash device may comprise an energy store which is rechargeable.

The flash device may comprise a capacitor charging means electrically arranged to charge the energy store.

Such an energy store ensures that the flash device may be reusable.

The flash device may comprise a control unit connected to the capacitor charging means.

The control unit may be configured for driving the at least one array of light emitting elements in a pulse mode when the device is activated such that in operation the array of light emitting elements may switch between a high power output condition and a low power output condition repeatedly. The pulse mode may be such that the array of light emitting elements may switch between conditions at a frequency predetermined to disorientate nearby personnel.

The low power output mode is substantially zero watts.

Each array of light emitting elements may be an array of light emitting diodes (LEDs). Further the array of LEDs may comprise at least 20 LEDs.

The power unit may be operable to deliver output power of at least 5 kW to the at least one light emission unit.

The operator interface may be configured to enable selection between initiation modes. The initiation modes may comprise any combination of: an instant initiation, a delayed initiation, a wirelessly controlled initiation, or, a passive infra-red detection initiation.

The operator interface may be configured to enable selection between activation modes. The activation modes may comprise: a pulse mode where the light emitting elements may switch between a high power output condition and a low power output condition repeatedly or a continuous power output mode where the power output is substantially constant.

The power unit may comprise a power and control bus.

Such a power and control bus enables the effective control and distribution of power to a single or multiple light emissions units.

The power unit may be configured to be removable.

Such a power unit enables the device to be transported safely as the device may not be activated with the power unit removed. Such a power unit also enables a number of power units to be prepared for activation then attached to the device at the time of use.

According to a second aspect of the invention there is provided a flash grenade comprising a flash device as described herein.

According to a third aspect of present invention there is provided a flash grenade for selective activation where upon activation the grenade may emit at least 100,000 lumens, the flash grenade comprising, an operator interface a power source, a plurality of light emission units each connected to the power source independently and comprising: an array of light emitting elements; a power converter unit for driving the array, and a control unit independently connected to each light emission unit, the control unit comprising a processor and being operably connected to the operator interface.

According to a fourth aspect of the invention there is provided an acoustic module for a flash device comprising: a connector for attachment to a flash device; an acoustic signal generator for generating at least one predetermined acoustic signal at or around a predetermined frequency.

The acoustic module may further comprise an acoustic cavity configured to substantially resonate at the predetermined frequency.

The connector may be for detachable attachment.

The connector may be for conveying electrical signals when connected to a reciprocally configured connector at a flash device.

The connector may be for conveying electrical power when connected to a reciprocally configured connector at a flash device.

The acoustic module may be configured to produce at least 100 dB.

The acoustic module may be configured to operate synchronously with a flash device to which the module can be connected.

The acoustic module may be activated and/or pre-programmed by way of a remote operator interface.

So that the invention may be well understood, embodiments thereof shall now be described with reference to the following figures, of which:

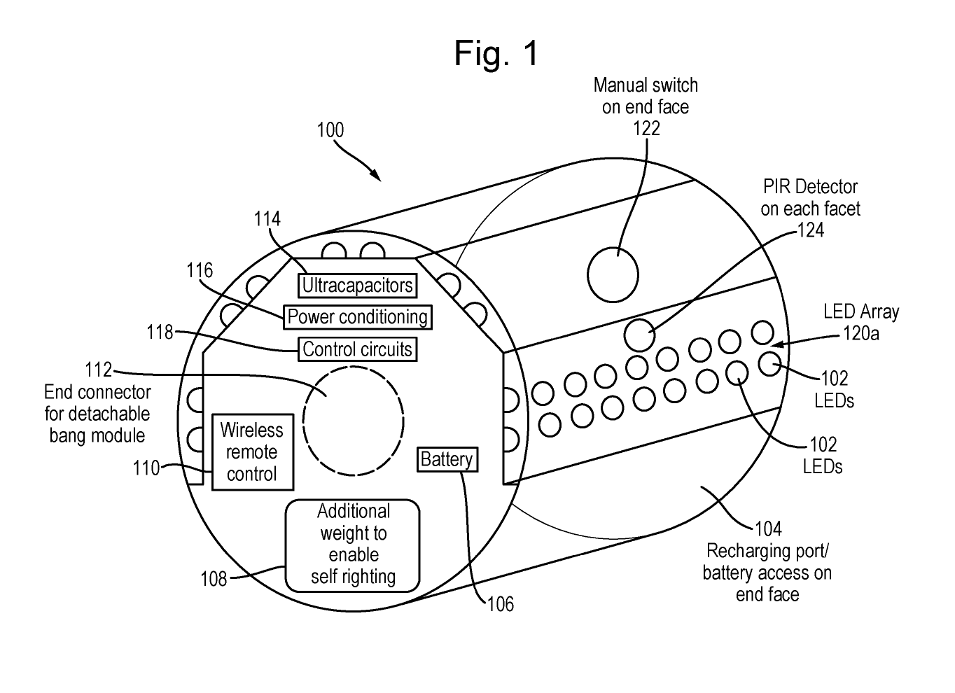

FIG. 1 shows a three-dimensional representation of a handheld flash device according to the present invention;

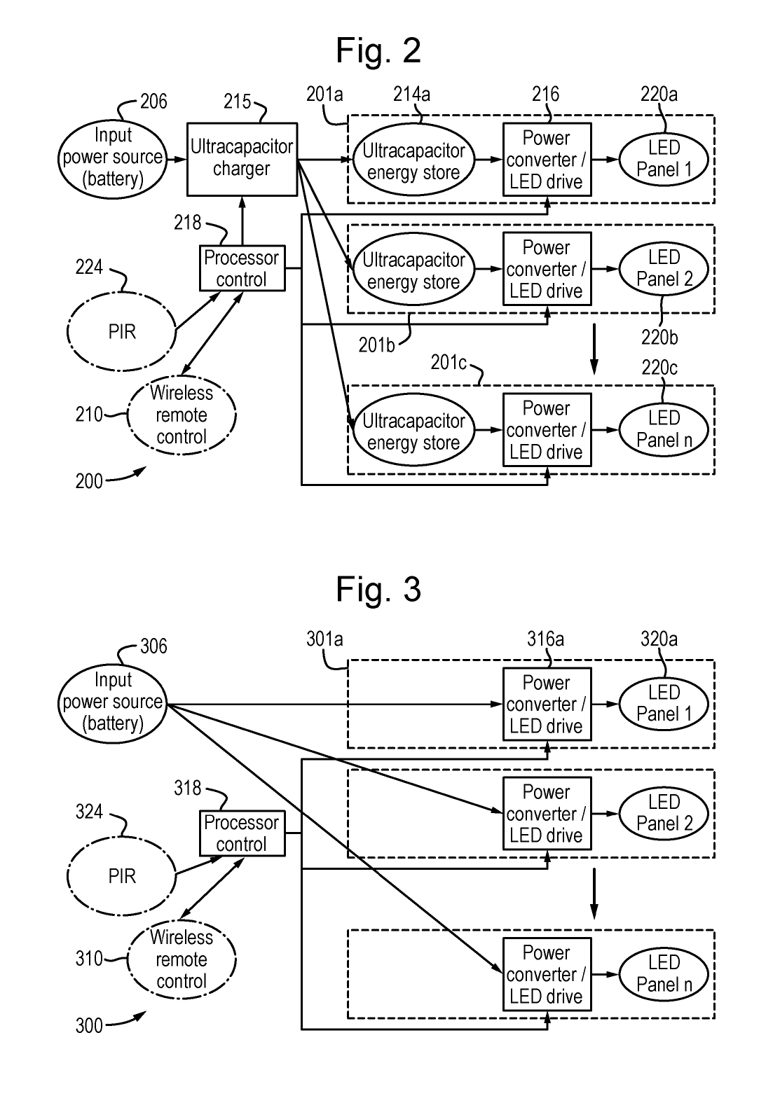

FIG. 2 shows a schematic diagram of an embodiment of a flash device according to the present invention;

FIG. 3 shows a schematic diagram of a further embodiment of a flash device according to the present invention;

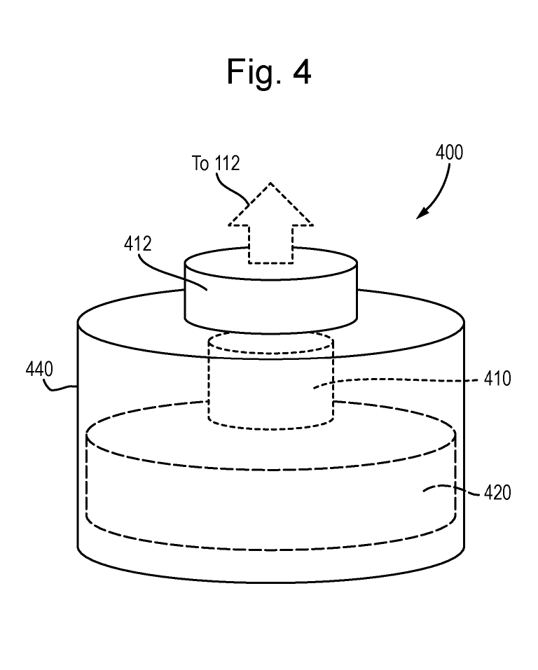

FIG. 4 shows a schematic diagram of a modular acoustic attachment which may be provided as part of the flash device; and

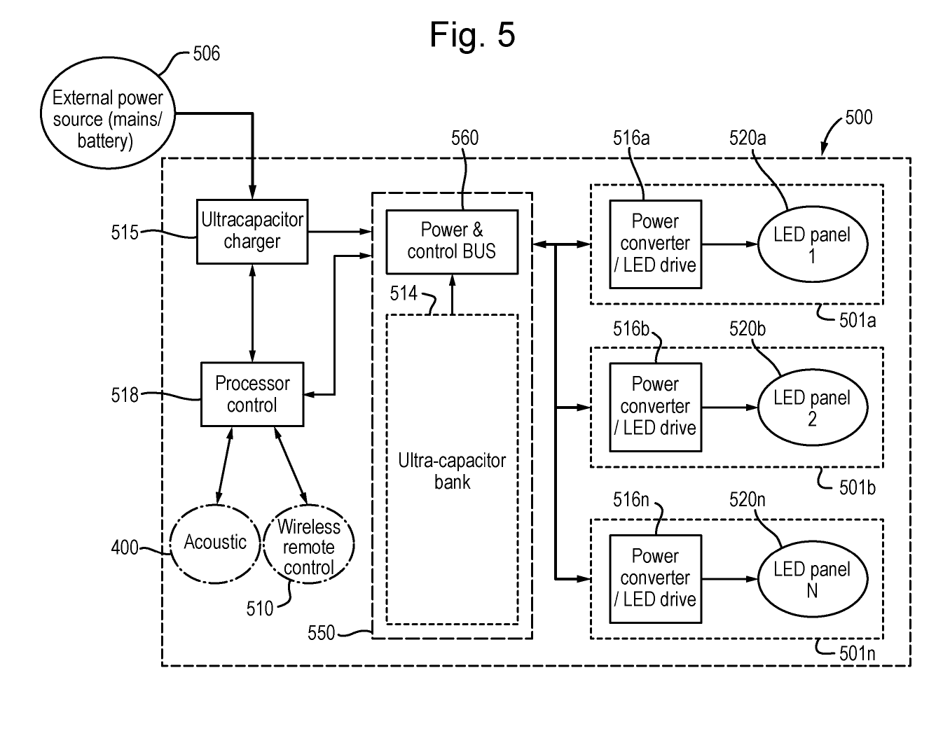

FIG. 5 shows a schematic diagram of a yet further embodiment of a flash device according to the present invention.

With reference to FIG. 1 there is shown generally at 100 a handheld flash device. The device 100 comprises a substantially cylindrical housing 130 which accommodates a plurality of LEDs 102 arranged as LED arrays 120a, 120b. The housing 130 further accommodates a power source 106, a means for adjusting its standing position 108, a transceiver 110 for wireless control of the device, an array of ultracapacitors 114 (which may be arranged as a plurality of arrays), a power converter unit 116 (which may be arranged as a plurality of converter units) for driving the LEDs, and a control unit 118.

The housing 130 has a substantially circular front and back face which are substantially parallel and separated by an interconnecting side wall surface. Incorporated into the interconnecting side wall, the housing 130 has facets arranged to extend axially between the substantially circular faces of the cylindrical housing 130. Each of these facets has arranged at it an array of LEDs, such as LED array 120a. Further, each facet is provided with a PIR sensor 124.

Additionally the housing accommodates an end connector 112 at the front face of the housing for attaching and electrically interfacing an optional noise producing module, as will be later discussed with reference to FIG. 4.

A manual switch 122 is provided at the back face of the housing for selectively switching the device 100 between and cony mode (where the device 100 may emit light if so instructed) and an ‘off’ mode (where the device 100 may not emit light).

Also provided at the back face of the housing 130 is an access panel or port 104 whereby either the power unit 106 can be removed (and replaced), or a recharging energy source can be coupled into the source 106 to recharge it.

In operation, the handheld device 100 may be picked up by an operator, switched manually from the ‘off’ mode to the cony mode using switch 122 and subsequently thrown into a hostile environment. A subsequent instruction received from the wireless transceiver 110 (which may be delivered by a remote control retained by the operator) causes the battery 106 to transfer energy, via the power converter units 116 and/or ultracapacitors 114 to the LED arrays 120a and 120b, which then emit intense light and thereby disorientate adversaries proximate to the device 100.

FIG. 2 shows schematically a flash device 200, similar to device 100, where components similar to components in flash device 100 are incremented by 100. For instance the LED array 120a of the device 100 in FIG. 1 is similar to the LED array 220a of device 200.

With reference to FIG. 2, there is shown a device 200 provided with a plurality of light emission units 201. Each of the light emission units 201 comprises an ultracapacitor array 214, a power converter unit 216 and the LED array 220. The ultracapacitor array 214 is connected to the power converter unit 216 which is in turn connected to the LED array 220.

For instance, a light emission unit 201a comprises ultracapacitor array 214a, connected to power converter unit 216a connected to LED array 220a.

The device 200 is further provided with an ultracapacitor charger 215 connected to each of the arrays of ultracapacitors 214a, 214b and 214c. The ultracapacitor charger 215 is connected to a power source 206 such that the ultracapacitor charger 215 can receive and manage power from the source 206. This power source 206 could be an internal power source, for example, a battery, or an external power source, for example, a battery or mains power. The ultracapacitor charger 215 is further connected to a control unit 218 such that it may send and receive signals from the control unit 218.

The control unit 218 is additionally connected to each of the power converter units 216a, 216b and 216c such that it can send and receive signals to and from these units.

Still further, the control unit 218 is connected to various interface units, such as a PIR sensor unit 224 and a wireless control unit 210 (which may be provided as part of a broader operator interface including also a manual remote control unit) such that the control unit 218 may act in dependence on signals received from these.

The control unit 218 comprises a signal generator (not shown) and/or clock for generating a periodic signal that varies between an upper value and a lower value at a predetermined frequency.

In operation, a disorienting light emission may be effected.

Each ultracapacitor array 214a, 214b, and 214c is driven by the ultracapacitor charger 215, under instruction from the control unit 218 such that the charging of the ultracapacitor array is regulated such that should the LED array need activation at a predetermined time, the ultracapacitor array is able to discharge through the power converter unit 216 into the LED array 220 (and thereby put the device 200 is a high power output mode) in a predetermined manner.

In particular the ultracapacitor arrays may be driven to charge during one phase of a cycle of the periodic signal generated at the control unit 218 and then may be driven to discharge during the second phase of a cycle of the periodic signal.

Accordingly the LED arrays may be switched between a high power mode (i.e. as the ultracapacitor array 214 discharges into the LED array 220) and a low power mode (i.e. as the ultracapacitor array 214 is charged).

FIG. 3 shows schematically a flash device 300, similar to device 100, where components similar to components in flash device 100 are incremented by 200. For instance the LED array 120a of the device 100 in FIG. 1 is similar to the LED array 320a of device 300.

As such, with reference FIG. 3 there is shown generally at 300 a further schematic embodiment of a flash device. As compared with the FIG. 2 embodiment, this flash device 300 tends to do away with the ultracapacitor arrays 214a, 214b, 214c and the associated charger 215.

Thus in this FIG. 3 embodiment, the light emission units 301 comprise a power converter unit 316 connected to a LED array 320.

A power source 306 is connected to each of the power converters 316a, 316b and 316c. This power source 306 could be an internal power source, for example, a battery, or an external power source, for example, a battery or mains power. A control unit 318 is connected to each of the power converters 316a, 316b and 316c. The control unit 318 is also connected to various interface units, such as a PIR sensor unit 324 and a wireless control unit 310 (which may be provided as part of a broader operator interface including also a manual remote control unit) such that the control unit 318 may act in dependence on signals received from these.

In operation, the flash device 300 activates at least one of the LED arrays 320a, 320b, and 320c when the associated power converter unit 316a, 316b, or 316c is instructed by a signal from the control unit 318 to pass electrical energy from the power source 306 to its associated LED array. With energy being transferred from the power source 306 to an LED array 302, the device 300 is placed in a high power mode of operation.

The instruction to pass energy between the power source 306 and some or all of the LED arrays 320a, 320b, 320c may be in the form of a periodic signal having a first phase of a cycle and a second phase of a cycle such that the first phase of the cycle causes activation of the LED arrays 320a, 320b, 320c (i.e. electrical energy is supplied to the LED arrays 320a, 320b, 320c) and the second portion of the cycle causes deactivation (i.e. not electrical energy supplied to the arrays).

FIG. 5 shows schematically a flash device 500, similar to device 100, 200 and 300 where components similar to components in flash devices 100, 200 and 300 are incremented by 100. For instance the LED array 120a of the device 100 in FIG. 1 is similar to the LED array 520a of device 500.

As such, with reference FIG. 5 there is shown generally at 500 a further schematic embodiment of a flash device. As compared with the FIG. 2 embodiment, this flash device has a power unit 550 comprising an ultracapacitor bank 514 connected via a power and control bus 560 to a number of light emission units 501a, 501b and 501n.

The power unit 550 is connected to each of the power converters 516a, 516b and 516n. A control unit 518 is operably connected to each of the power converters 516a, 516b and 516n via a power and control bus 560. The control unit 518 is also connected to various interface units, such as an acoustic disorientation unit 400 and a wireless remote control 510 (which may be provided as part of a broader operator interface including also a manual remote control unit) such that the control unit 518 may act in dependence on signals received from these.

The control unit 518 can be programmed to alter the flash pulse and intensity of the light emitting elements 520a, 520b and 520n, and can also enable a randomised pulse setting.

The independent coupling of the control unit 518 to each light emission unit 501a, 501b and 501n, and the provision of a power converter 516a, 516b and 516n at each light emission unit 501a, 501b and 501, provides the flash device 500 with redundancy in case a part fails in service.

The power unit 550 is removable and therefore may be charged independently of the flash device 500. This enables a bespoke power unit to be used which is applicable to the application. This bespoke power unit may be a lithium battery or a different sized ultracapacitor bank. The power unit also contains a bleed resistor (not shown) which enables the ultracapacitor bank 514 to be dissipated of power prior to storage. The ultracapacitor bank 514 contains the charge electronics necessary for it to be charged prior to insertion into the flash device 500.

The reliability of the device is further enhanced by the modular design of the flash device 500. The light emission units 501a, 501b and 501n may be removed and replaced with spares as can the power unit 550 as described above. The light emission units 501a, 501b and 501n can also be changed to comprise light emitting elements 520a, 520b and 520n with different wavelengths. This is especially useful when dealing with a technologically aware target which may have access to eyewear to neutralise a flash device. Changing the wavelength of the light emitting elements 520a, 520b and 520n can enable the user to neutralise the protection offered by the eyewear of the target.

In this embodiment an external power source 506 can be connected to the flash device 500 which charges the ultracapacitor bank 514 via an ultracapacitor charger 513. The external power source 506 may be changed to enable faster charging of the ultracapacitor bank 514. A 12 v input supply power source 506 charges the ultracapacitor bank 514 in approximately 10 minutes.

However, if the charging voltage and current supply is increased the ultracapacitor bank 514 can be charged in 10-20 seconds.

In addition the flash device 500 can be tethered to an external power source 506 enabling continuous operation.

In general operation any of the devices 100, 200, 300 or 500 may be used as follows.

An operator firstly identifies an enclosure, particularly a building, containing targets for disorientation.

The operator then throws or otherwise deploys the flash device into the building (having first set the device into the cony mode).

The operator then selects that the flash device be activated. This selection may be by means of an instruction to the device issued, via an operator-held remote control device, to the wireless transceiver. Alternatively this instruction may have been made prior to deployment of the device by setting a countdown timer (using a clock in the control unit) such that at the end of the countdown, the device is activated.

Upon activation the LED arrays are illuminated (the particular mechanism of illumination depending on whether the FIG. 2 to FIG. 5 arrangement is used). In general this illumination will be a high frequency periodic illumination where the LED arrays activated switch between a high power output mode and a low power output mode.

Alternatively, the flash device could be integrated into a security system for a building, vehicle or space and activated when an intruder accesses the building, vehicle or space. In this embodiment the flash device could be connected to mains power or the vehicle battery in order that the disorientation continues until the appropriate authorities arrive or until the flash device is deactivated.

The flash devices contemplated above may be provided with a modular attachment for enhancing the disorientation effect by providing the option of deploying an acoustic disorientation effect.

As such, the acoustic disorientation device (or module) 400 is provided. With reference to FIG. 4, the acoustic disorientation device 400 has the general form of a puck and as such the acoustic disorientation device 400 is generally cylindrical with its diameter greater than its depth.

The acoustic disorientation device 400 can be attached to the flash device system 100. Where the acoustic disorientation device is in the form of a puck as shown in FIG. 4, the disorientation device 400 may attach to the flash device 100 such that the main cylindrical axis is aligned with the axis of the device 100.

The acoustic disorientation device 400 comprises a main body or housing 440 featuring a mating connector 412, an acoustic signal generator 410 and an acoustic resonator cavity 410. The mating connector 412 is electrically connected to the acoustic signal generator 410.

The mating connector 412 is suitable for mechanically fastening and unfastening from the end connector 112 on the flash device 100. As such the connector 412 provides a detachable fixture.

Further, the mating connector 412 interfaces with the flash device 100 such that when mechanically fastened together, electrical signals and power from the flash device 100 may be relayed to the acoustic disorientation device 400.

In particular, signals may be relayed over the connectors 112, 412 from the control circuits 118 to the acoustic signal generator 410, which signals activate the acoustic signal generator 410 to cause the emission of acoustic waves.

The acoustic signal generator 410 is arranged to transmit acoustic waves into the resonator cavity 420. The resonator cavity 420 is a hollow chamber within the main body 440 configured to have dimensions suitable for amplifying the acoustic signal by resonance.

Thus in use the acoustic disorientation device can generate sufficiently powerful acoustic waves to disorient proximate personnel. In particular it is expected that the disorientation device 400 can emit 100 dB of sound or more.

The waveforms of the acoustic waves generated by the acoustic wave generator can be predetermined by the user. For instance the waveforms can be pre-programmed into the control circuits 118 and selectively activated via the operator interface.

The acoustic waves generated by the device 400 may operate synchronously with the flash system. For instance the acoustic disorientation device 400 may periodically alternate between a phase of acoustic wave emission and a phase of general silence. This periodic alternation may be coherent with and have the same period as the high power and low power phases of the pulsed optical disorientation signal.

In operation the acoustic disorientation device 400 can be fastened to the flash device 100. From here, the acoustic disorientation device 400 can be turned on, deployed and activated in an equivalent manner to the LED illumination described above.

Alternative versions of the acoustic disorientation device (or module) 400 could comprise an integral power source and signal receiver such that there was no necessity for electrical power and signals to be conveyed across the connector 112.

Alternative versions of the acoustic disorientation device (or module) 400 could be provided without an acoustic cavity.

1. A flash device for selective activation whereupon activation the flash device may emit at least 100,000 lumens, the flash device comprising:
an operator interface;
a power unit comprising an energy store;
at least one light emission unit connected to the power unit and including
an array of light emitting elements, and
a power converter unit for driving the array; and
a control unit operably connected to the at least one light emission unit, the control unit comprising a processor and being operably connected to the operator interface.

2. The flash device according to claim 1, wherein the energy store contains only a capacitive energy store.

3. The flash device according to claim 1, wherein the energy store is rechargeable.

4. The flash device according to claim 2, further comprising a capacitor charging circuitry electrically arranged to charge the energy store.

5. The flash device according to claim 4, wherein the capacitor charging circuitry is connected to the control unit.

6. The flash device according to claim 1, wherein the control unit is configured for driving the array of light emitting elements in a pulse mode when the flash device is activated such that in operation the array of light emitting elements may switch between a high power output condition and a low power output condition repeatedly.

7. The flash device according to claim 6, wherein the pulse mode is such that the array of light emitting elements switch between the high and low power output conditions at a frequency predetermined to disorientate nearby personnel.

8. The flash device according to claim 6, wherein the low power output condition is substantially zero watts.

9. The flash device according to claim 1, wherein the power unit is operable to deliver output power of at least 5 kW to the at least one light emission unit.

10. The flash device according to claim 1, wherein the operator interface is configured to enable selection between initiation modes.

11. The flash device according to claim 10, wherein the initiation modes comprise any combination of: an instant initiation, a delayed initiation, a wirelessly controlled initiation, and/or a passive infra-red detection initiation.

12. The flash device according to claim 1, wherein the operator interface is configured to enable selection between activation modes.

13. The flash device according to claim 12, wherein the activation modes comprise: a pulse mode where the light emitting elements may switch between a high power output condition and a low power output condition repeatedly, and/or a continuous power output mode where the power output is substantially constant.

14. The flash device according to claim 1, wherein the power unit further comprises a power and control bus.

15. The flash device according to claim 1, wherein the power unit is configured to be removable.

16. A flash grenade comprising the flash device according to claim 1.

17. A flash device, comprising:
an operator interface;
a power unit comprising a rechargeable energy store;
at least one light emission unit connected to the power unit and including
an array of light emitting elements, and
a power converter unit for driving the array; and
a control unit operably connected to the at least one light emission unit, the control unit comprising a processor and being operably connected to the operator interface, wherein the control unit is configured for driving the array of light emitting elements in a pulse mode that causes the array of light emitting elements to switch between a first power output condition and a second power output condition at a pre-established frequency.

18. A munition comprising the flash device according to claim 17.

19. A flash device, comprising:
an operator interface configured to enable selection between activation modes, the activation modes including
a pulse mode where the light emitting elements switch between a first power output condition and a second power output condition at a pre-established frequency, and
a continuous power output mode where the power output is substantially constant;
a power unit comprising a rechargeable energy store;
at least one light emission unit connected to the power unit and including
an array of light emitting elements, and
a power converter unit for driving the array; and
a control unit operably connected to the at least one light emission unit, the control unit comprising a processor and being operably connected to the operator interface, and wherein the control unit is configured for driving the array of light emitting elements in the pulse mode or the continuous mode.

20. A munition comprising the flash device according to claim 19.
